(19) United States
(12) Patent Application Publication
(10) Pub. No.: US 2013/0239902 A1
(43) Pub. Date: Sep. 19, 2013

(54) PET CAGE FOR ATTACHMENT TO A VEHICLE

(71) Applicant: BIG BOY CAGE MOBILE INC., Gatineau (CA)

(72) Inventor: JULIEN VENNE, GATINEAU (CA)

(73) Assignee: BIG BOY CAGE MOBILE INC., GATINEAU (CA)

(21) Appl. No.: 13/795,681

(22) Filed: Mar. 12, 2013

Related U.S. Application Data
(60) Provisional application No. 61/610,541, filed on Mar. 14, 2012.

(30) Foreign Application Priority Data
Mar. 14, 2012 (CA) 2771859

(51) Int. Cl. A01K 1/00

(52) U.S. Cl. CPC A01K 1/0035
USPC 119/453

(57) ABSTRACT

There is provided a pet cage for attachment to a trailer hitch of a vehicle, the cage comprising a floor, one or more sidewalls and a top panel, the floor, the sidewalls and the top panel being attached together and defining an enclosed space for accommodating a pet; a door fitted in one of the sidewalls; and a support attached to the floor, the sidewalls and/or the top panel for supporting the cage above ground, the support having a coupling end for attachment to the trailer hitch of the vehicle.

### CROSS REFERENCE TO RELATED APPLICATIONS

This application claims benefit, under 35 U.S.C. §119(e), of U.S. provisional application Ser. No. 61/610,541 filed on Mar. 14, 2012 and Canadian patent application No. CA 2,771,859 filed on Mar. 14, 2012. All documents above are incorporated herein in their entirety by reference.

### FIELD OF THE INVENTION

The present invention relates to a pet cage for attachment to a vehicle. More specifically, the present invention is concerned with a pet cage that is attached to and supported by the trailer hitch of a vehicle.

### BACKGROUND OF THE INVENTION

Large breed dogs are common companion dogs. They are also often used as working dogs for hunting, sleigh pulling, etc. Dog owners often need to transport their dog(s) to different locations using their family vehicle. Various devices have been used to this end.

First, conventional pet cages are known and come in all shapes and sizes. The most common cages are plastic and/or metallic rectangular cages with a door. Pet carriers made of textile are also commonly encountered. These cages and carriers can be used to carry pets in vehicles given that they can be secured to the vehicle.

Then, there are also cages especially made for the transportation of pets in vehicles. These cages are generally of irregular shape to best fit on the back seat of a vehicle or in the cargo space of a hatchback vehicle.

Other devices to transport pets in vehicles include safety harnesses worn around the chest and neck of the dog, and attached using the safety belts of the vehicle. Various barriers can also be installed between the front and back seat of a vehicle or between the back seat and the cargo space of a hatchback vehicle. These barriers restrain the pet to the back of the vehicle away from the driver.

All these means of vehicle pet transportation have one or more drawbacks. The most apparent of these drawbacks is that they are not designed to accommodate large dogs. Many large breed dogs are simply too large to fit in a smaller vehicle such as a car. Apart from shear space issues, it should indeed be remembered that a properly confined dog should always have enough space to lie down and to turn around. In consequence, even if the dog fits in the vehicle, a cage big enough to properly accommodate the dog may not fit. Therefore, the above discussed cages and carriers are of little use for the owners of many large breed dogs. Further, dogs must be safely restrained in case of collision. Barriers and harnesses, which are often strong enough to resist to the weight of a smaller dog being propelled by an impact, may not resist when a larger dog is involved.

Other drawbacks of transporting pets inside a vehicle include the loss of space for people and cargo as well as the soiling of the vehicle by the pet (drooling and other bodily fluids, water/dig on paws and fur, etc.).

Other means of transporting animals include wheeled trailers towed by larger vehicles such as pickup trucks. These trailers are often multi-dog trailers (4, 6 or 8 animals) for use by kennels, shelters, dog pounds and the like. These are usually too large and heavy to be pulled by smaller vehicles, such as family cars. Given their intended use, the berths of these trailers are not always designed for large breed dogs and will rather better accommodate several smaller dogs. The berths are also often almost completely enclosed, having only mere air holes. Considering their intended kennel/shelter/dog pound use, this may be appropriate as the animals will not regularly ride in the trailer. However, this is not desirable for a pet owner that need to regularly transport her own dog(s).

Large dogs are sometime carried in the back of pickup trucks. If the dog is loose, it can escape or be projected out of the vehicle if a collision occurs. If the dog is attached, for example using a leach, it may be hurt or even strangled if it tries to escape or if a collision occurs.

### SUMMARY OF THE INVENTION

In accordance with the present invention, there is provided:
1. A pet cage for attachment to a trailer hitch of a vehicle, the cage comprising:
   a floor, one or more sidewalls and a top panel, the floor, the sidewalls and the top panel being attached together and defining an enclosed space for accommodating a pet;
   a door fitted in one of the sidewalls; and
   a support attached to the floor, the sidewalls and/or the top panel for supporting the cage above ground, the support having a coupling end for attachment to the trailer hitch of the vehicle.
2. The cage of item 1, wherein, when the cage is installed on a vehicle, the support holds the cage at a distance from the ground that is equal to or larger than the distance from the ground to the trailer hitch.
3. The cage of item 2, wherein the support holds the cage at a distance from the ground larger than the distance from the ground to the trailer hitch.
4. The cage of item 3, wherein the support holds the cage at more than 12 inches from the ground.
5. The cage of item 4, wherein the support holds the cage at more than 16 inches from the ground.
6. The cage of item 5, wherein the support holds the cage at 18 inches or more from the ground.
7. The cage of any one of items 1 to 6, further comprising a pin for inserting into a hole located at the coupling end of the support so as to removably attach the support to the trailer hitch.
8. The cage of any one of items 1 to 7, wherein the coupling end of the support is less than 12 inches long.
9. The cage of any one of items 1 to 8, wherein the support extends under and is attached to the floor of the cage.
10. The cage of item 9, wherein one or more of the sidewalls extend downward from the floor so as to at least partly hide the support from view.
11. The cage of item 9 or 10, wherein the support comprises one or more arms extending from the coupling end under the floor of the cage.
12. The cage of item 11, wherein the arm(s) slope upward from the trailer hitch.
13. The cage of item 11, wherein the arm(s) are stepped.
14. The cage of any one of items 11 to 13, wherein one or more brackets vertically extend from the arm(s) of the support and attach to the floor of the cage.
15. The cage of item 14, wherein two brackets extend vertically from the arm(s) of the support and attach to the floor of the cage.
16. The cage of item 14 or 15, wherein the brackets attach to the floor under weight bearing portions thereof.

17. The cage of any one of items 14 to 16, wherein the brackets are L-shaped with a portion extending vertically from the arm(s) and a further portion extending horizontally from the vertical portion, the horizontal portion attaching to the floor of the cage.
18. The cage of any one of items 14 to 17, wherein the width of the brackets is about 25 to about 50% of the width of the floor.
19. The cage of any one of items 9 to 18, wherein the support comprises one central arm extending under the floor of the cage.
20. The cage of item 19 comprising two brackets, wherein the arm(s) are stepped or slope upward from the trailer hitch, and wherein the bracket closest to the coupling end extends vertically upwards and the bracket farthest from the coupling ends extend vertically downwards.
21. The cage of item 19 or 20, wherein the central arm and the coupling end together consist in a bent square metal tube having an opening of a size adapted to engage and retain the trailer hitch.
22. The cage of any one of items 1 to 21 having a square or rectangular floor and comprising four sidewalls.
23. The cage of any one of items 1 to 22 wherein part of the floor, the sidewalls and/or the top panel is made of perforated metal or metal lattice.
24. The cage of any one of items 1 to 23, wherein the door comprises a panel of perforated metal or metal lattice in a metal frame.
25. The cage of item 23 or 24, wherein the metal is aluminium.
26. The cage of any one of items 1 to 25, comprising two doors fitted in a sidewall, the doors meeting in the middle of the sidewall when closed.
27. The cage of any one of items 1 to 26, wherein the door(s) is(are) fitted in a sidewall facing away from the vehicle when the cage is attached to the vehicle.
28. The cage of any one of items 1 to 27, further comprising a reinforcement frame running along and attached to the edges of each of the floor, top panel and the sidewalls.
29. The cage of any one of items 1 to 28, wherein one or more of the sidewalls and/or the door(s) comprise one or more openings to allow the dog to put at least part of its head out of the cage.
30. The cage of any one of items 1 to 29, further comprising one or more stabilizing belts for attachment to the cage and to the vehicle so as to limit rocking of the cage.
31. The cage of any one of items 1 to 30, further comprising a license plate frame located on a sidewall facing away from the vehicle when the cage is attached to the vehicle.
32. The cage of any one of items 1 to 31, further comprising rear position lamps, stop lamps and/or turning signals installed on one or more of the sidewalls.

### BRIEF DESCRIPTION OF THE DRAWINGS

In the appended drawings:

FIG. 1 is a high three quarter view of a pet cage according to an embodiment of the invention;

FIG. 2 is an elevation view of the front wall of the pet cage;

FIG. 3 is an elevation view of the left sidewall of the pet cage;

FIG. 4 is an elevation view of the back wall of the pet cage;

FIG. 5 is a plan view of the support for attaching the pet cage to the trailer hitch of a vehicle;

FIG. 6 is a elevation view of the support viewed from the side;

FIG. 7 is elevation view of the support viewed from the back;

FIG. 8 is a sectional view of the pet cage along its left/right axis;

FIG. 9 is a photograph showing a pet cage according to another embodiment of the invention, the cage being installed on a car; and

FIG. 10 is a photograph showing the left sidewall and part of the back wall of the cage.

### DETAILED DESCRIPTION OF THE INVENTION

Turning now to the invention in more details, there is provided a pet cage for attachment to a trailer hitch of a vehicle, the cage comprising:
a floor, one or more sidewalls and a top panel, the floor, the sidewalls and the top panel being attached together and defining an enclosed space for accommodating a pet;
a door fitted in one of the sidewalls; and
a support attached to the floor, the sidewalls and/or the top panel for supporting the cage above ground, the support having a coupling end for attachment to the trailer hitch.

The number of sidewalls necessary to create the enclosed space will depend on the shape of the cage. A cage with a round floor may only need one curved sidewall. A cage with a square or rectangular floor will typically need four sidewalls. In such embodiments, the sidewalls can be distinguished by calling the wall facing the vehicle the “back wall”, the wall facing away from the vehicle the “front wall” and the two other walls the left and ride sidewalls.

The enclosed space can be of any size suitable for one or more pet(s). For example, the dimensions of the cage can be 24×24×36 inches, 30×30×36 inches, 30×30×30 inches or 42×30×48 inches (height×depth×width).

The sidewalls, floor and top panel can be made of any material that is suitably strong and light, for example, sheets of metal, metal lattice or perforated metal. In embodiments, the sidewalls, floor and top panel are made of sheets of galvanized aluminium, perforated aluminium and/or aluminium lattice. In embodiments, the sidewalls, floor, and top panel are partly made of galvanized aluminium and partly made of perforated aluminium or aluminium lattice. Any part of the cage can be strengthened as desired using metal bars or supports located either outside or inside the cage.

In embodiments, the floor of the cage is almost completely made of perforated aluminium or aluminium lattice reinforced with two equally space L-shaped metal bars located beneath the floor and running from side to side of the cage. The use of perforated metal or metal lattice, especially for the floor, makes the cage very easy to clean, for example by hosing.

In embodiments, the use perforated metal or metal lattice for the top panel is restricted, for example to a portion thereof, to protect the pet from the rain and snow.

The use of aluminium allows reducing the weight of the cage. The use of perforated metal or metal lattice, in particular perforated aluminium or aluminium lattice, also reduces this weight. It should be noted that the total weight of the cage should ideally not exceed about 10% of the towing capacity of the vehicle. This allows easily manoeuvring the vehicle without increasing wear.

The cage comprises a door fitted in one of the sidewalls. This door allows the pet to enter the cage. The door can be fitted with any kind of handle for opening and closing the door and preventing the pet from accidentally getting out of the cage. In embodiments, two doors (or a double door) are fitted in a sidewall. These doors can meet in the middle of a sidewall when closed. This is particularly useful for big dogs. In embodiment, the door(s) are fitted on the sidewall looking away from the vehicle (i.e. the front wall). The door(s) can be of the same material as the sidewalls, floor, and top panel or another material. In embodiments, the door(s) are partly made of galvanized aluminium and partly made of perforated aluminium or aluminium lattice. For example, the door(s) can comprise a panel of perforated aluminium or aluminium lattice in a frame of galvanized aluminium.

The pet cage also comprises a support for attaching the cage to the trailer hitch. This support supports the cage above the ground. It should be noted that the cage does not need wheels to support its weight (in contrast with a trailer that does). Rather, the weight of the cage is supported by the trailer hitch. In other words, the cage does not touch the ground.

The support may be attached to the floor, the sidewalls and/or the top panel of the cage. The specific configuration of the support is not critical as long as it allows supporting the cage on the trailer hitch.

The support has a coupling end for attachment to the trailer hitch. The exact configuration of this coupling end is not critical as long as it allows securing the cage on the hitch in a way that the cage is supported by the hitch. In specific embodiments, the coupling end is a length of square metal tube of an appropriate material and size. The hitch is inserted in the tube and retained using for example a pin accommodated in a hole provided in the tube.

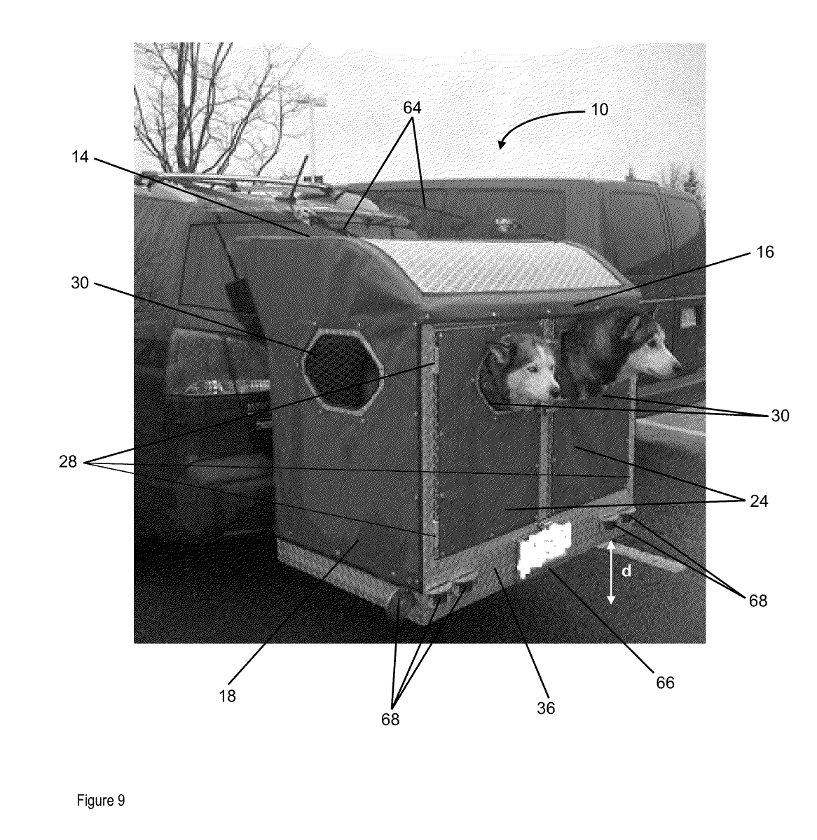

In embodiments, when the cage is installed on a vehicle, the support holds the cage at a distance from the ground that is equal to or larger than the distance from the ground to the trailer hitch. It is to be understood that at the coupling end of the support, the cage (of which the support is a part) cannot be higher than the trailer hitch of the vehicle. The above distance is thus the distance between the cage on its side facing away from the vehicle and the ground. The white arrow (d) in FIG. 9 shows this distance. In particular embodiments, the cage can be at more than 12 inches, more than 16 inches or at 18 inches or more of the ground. The above ground clearance allows manoeuvring the vehicle on more or less rough terrain without the cage touching the ground.

In embodiments, the support holds the cage quite close to the vehicle. For example, there can be less than 12 inches, for example 8 inches, between the vehicle and the sidewall closest to the vehicle. In embodiments therefore, the coupling end will be less than 12 inches, for example 8 inches long.

In embodiments, the support extends under the floor of the cage. In particular, the support can comprise more or one arm(s) extending from the coupling end under the floor of the cage. The arm(s) can be made of any sufficiently strong material, for example a metal, including steel, such as ⅛ inch thick steel. In particular, the arms can be ⅛ inch thick steel square steel tubes. In embodiments where the support is under the floor, one or more sidewalls can extend downward from the floor of the cage to partly hide the support from view.

In embodiments, the arm(s) can have one or more brackets vertically extending therefrom for making contact with and supporting the floor. The brackets extend vertically from the arm(s) toward the floor of the cage. They can located anywhere along the arm(s), but are preferably placed under weight bearing parts of the floor, such as that beneath the sidewalls. In embodiments, the brackets are placed under the floor opposite the back wall and front wall of the cage. In such embodiments, the support thus extends from the trailer hitch (on the back side of the cage), below the floor all the way to the front of the cage.

In embodiments, the brackets are L-shaped with a portion extending vertically from the arm(s) and a further portion extending horizontally therefrom. In such embodiments, the horizontal portion of each bracket bears the weight of the cage. Unless the floor of the cage is not flat, the horizontal portions of the brackets should be levelled so that the floor is levelled. It should be understood that, when the cage is installed, the floor may be slightly slanted for example going slightly upward as the distance from the vehicle increases.

The abovementioned ground clearance can be provided by having the arm(s) sloping upward at a more or less steep angle. The arm(s) can also be bent at a square angle to rise vertically and then be bent again to continue extending under the floor (in other word, the arm(s) can be stepped). In such cases, the bracket(s) closest to the trailer hitch may extend vertically upwards, while the bracket(s) farthest from the trailer hitch may extend vertically downwards. This mean that the horizontal portion of the closest bracket(s) will be located the top of the bracket(s), while the horizontal portion farthest bracket(s) will be located the bottom of the bracket(s).

The brackets, L-shaped or otherwise, may be narrow or wide. It is preferred that the bracket be narrow at their junction with the arm(s) and progressively widen until they make contact with the floor. In embodiments, the width of the brackets at the point they meet the floor can be about 25 to about 50% of the width of the floor. The wider the brackets, the less the cage will rock from side to side when a dog moves inside. In any case, the brackets should be of sufficient width and strength to support the weight of the cage and assure its stability.

In embodiments, the support comprises a single central arm from which two brackets vertically extend. In embodiments, the central arm together with the coupling end consist in a square metal tube having an opening of a size adapted to engage and retain the trailer hitch of the vehicle, for example 2×2 inches. In this case, the cage is installed on a vehicle by inserting the trailer hitch thereof into the void of the square tube constituting the central arm. The cage can then be secure by any conventional means, such as by inserting a pin into a hole located close to the coupling end of the central arm. The tube can be bent so that it slopes upward or is stepped. Then, at some distance from the trailer hitch, the tube can be bent so as to slope upward or to be stepped.

In embodiments, the cage comprises a frame. This frame runs along and is attached to the edges of each of the floor, top panel and sidewalls. The purpose of the frame is to strengthen the cage by supporting and better holding the floor, top panel and sidewalls together. This frame also improves the resistance of the cage in case of a collision. The frame can be made of any suitable material. The size of the internal frame will depend on the desired solidity of the cage. For example, in embodiments, the frame is made of square tubes of aluminium of 1″×1″×⅛″. The reinforcement frame can be inside or outside the pet enclosure. In embodiments, the frame is an internal frame.

In embodiments, the sidewalls and/or the door can comprise one or more openings. The purpose of these openings is to allow the dog to get its head (or part of it) out of the cage. As such, the opening(s) should be large enough to accommodate for example, the muzzle or the whole head of the dog. The openings should not be so large as to allow the dog to get outside the cage. The size of the openings will therefore depend on the size of the dog(s). Typically, size openings vary between about 6 to about 9 inches. The openings can be of any shape, depending on the desired aesthetics. The openings can be fitted with glass or plastic panes. Such embodiments are desirable when the dog is prone to ear infections caused by the wind.

In embodiments, air holes can be provided in the cage. Such holes are typically not necessary when any part of the cage is made of metal lattice of perforated metal or when the cage is provided with one or more (pane-free) openings. However, when the cage is relative airtight, it should be provided with air holes to allow the dog breathing.

In embodiments, one or more stabilizing belts are provided with the cage. These can be used to attach the cage to the vehicle and thus to limit any rocking of the cage caused by movements of the dog(s) inside. For example, a belt can be attached on a side of the cage (on a sidewall or on the top panel) and on the same side of the vehicle, while another belt is attached on the other side of the cage and vehicle. In an embodiment, a first belt is tensioned between a conventional support on the roof of the vehicle and the cage on one side thereof and a second belt is similarly tensioned on the other side of the vehicle and cage.

The cage can be provided with a licence plate frame typically located on the sidewall facing away from the vehicle. This frame is for the vehicle's licence plate, which in some cases may have to be transferred to the cage to be visible. It should be noted that, at least in some jurisdictions and unlike a trailer, the cage does not need its own licence plate.

The sidewalls of the cage can also bear rear position lamps, stop lamps and/or turning signals installed according to the regulations in force where the cage is used.

In use, the cage is installed on the trailer hitch and the door is opened to allow a dog of climb in the cage. The dog can then be safely transported to another location. Optional openings allow the dog to see outside. A (preferably impermeable and/or washable) cushion can be provided in the cage for more comfort. The dog is let out at destination.

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” means plus or minus 10% of the numerical value thus qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

List of Symbols

| Symbol | Part |
|---|---|
| 10 | Pet cage |
| 12 | Floor |
| 14 | Top panel |
| 16 | Front wall |
| 18, 20 | Left and right sidewalls |
| 22 | Back wall |
| 24 | Door(s) |
| 26 | Handle |
| 28 | Hinge(s) |
| 30 | Opening(s) |
| 32 | Support |
| 34 | Section of front wall (16) |
| 36 | Bottom panel of front wall (16) |
| 38 | Section of left sidewall (18) |
| 40 | Bottom panel of left sidewall (18) |
| 42 | Section of back wall (22) |
| 44 | Bottom panel of back wall (22) |
| 46 | Coupling end of the central arm (48) of support (32) |
| 48 | Central arm of support (32) |
| 50 | Back bracket |
| 52 | Front bracket |
| 54 | Horizontal portion of back bracket (50) |
| 56 | Horizontal portion of front brackets (52) |
| 58 | Hole |
| 60 | L-shaped support bars |
| 62 | Internal frame |
| 64 | Stabilizing belt |
| 66 | Licence plate frame |
| 68 | Rear position lamps, stop lamps and turning signals |
| 70 | Panel of the door (24) |
| 72 | Frame of the door (24) |
| d | Distance between the front wall (16) and the ground |

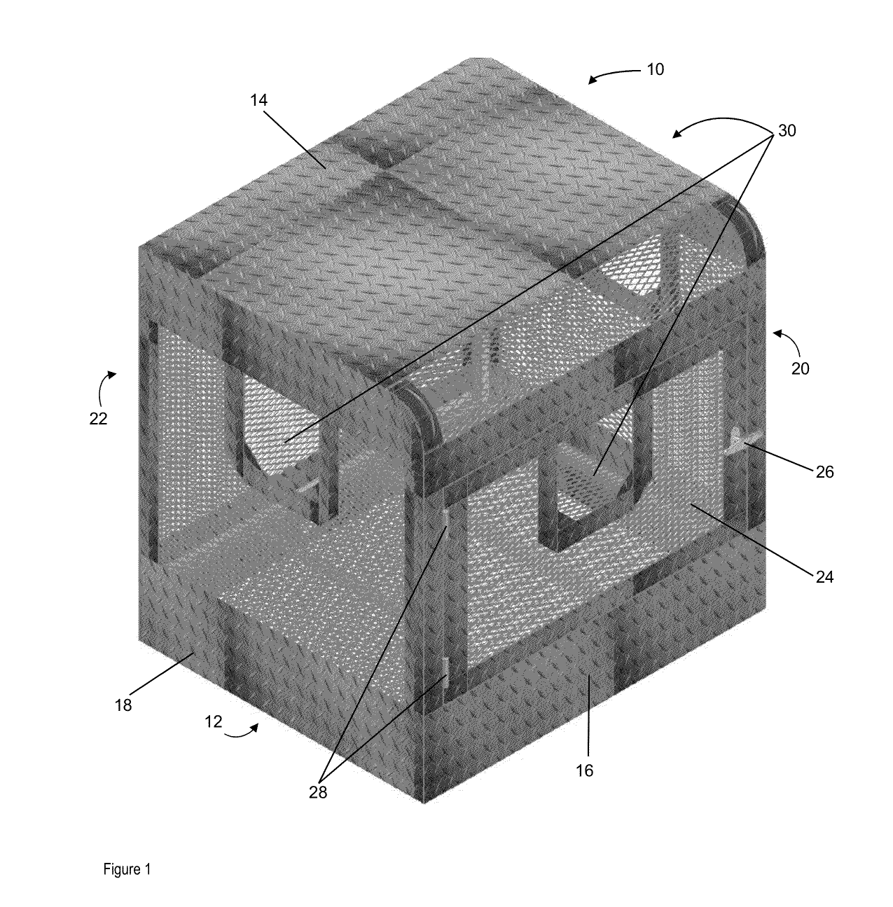

FIG. 1 is a high three quarter view of a pet cage (10) according to an embodiment of the invention. The cage (10) comprises a floor (12), a top panel (14) and four sidewalls consisting of a front wall (16), left and right sidewalls (18 and 20, respectively), and a back wall (22). Together, these sidewalls define a pet enclosure. When the cage (10) is installed on a vehicle, the back wall (22) faces the vehicle. The front wall (16) is fitted with a door (24) having a handle (26). The door (24) is mounted on hinges (28). Openings (30) are arranged in the left and right sidewalls (18 and 20) and in the door (24). The support (32) for attaching the cage (10) to the hitch of a vehicle is not shown on FIG. 1.

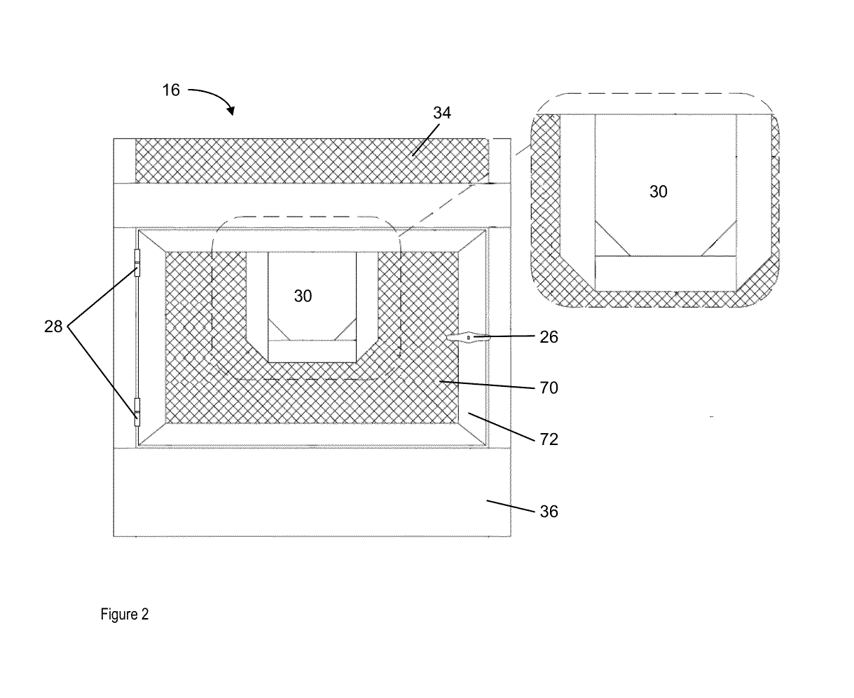

FIG. 2 is an elevation view of the front wall (16) of the cage (10) with a detailed view of the opening (30). As can be seen, the door (24) is made of a panel of metal lattice or perforated metal (70) in a frame (72). Further, a section (34) of the front wall (16) is also made of metal lattice or perforated metal. A panel (36) at the bottom of the front wall (16) hides from view the support (32) for attaching the cage (10) to the hitch of a vehicle.

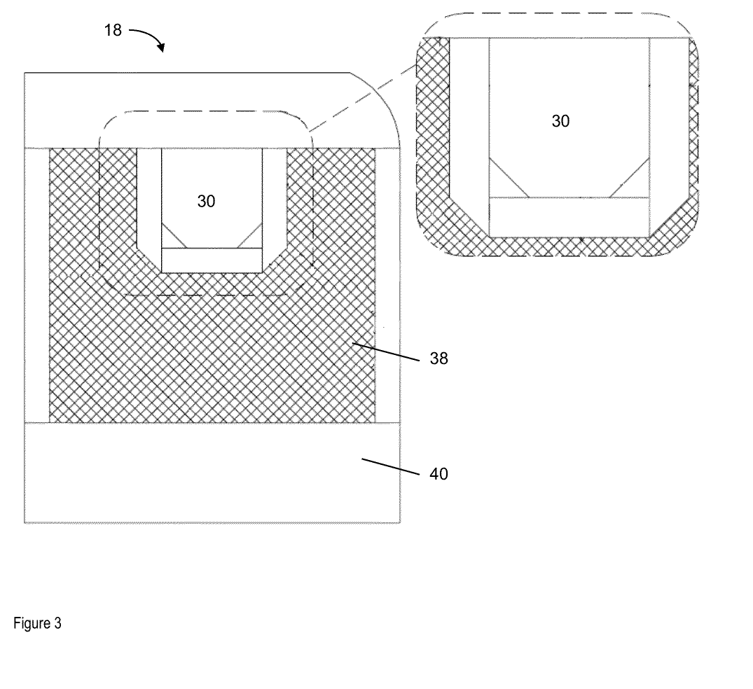

FIG. 3 is an elevation view of the left sidewall (18) of the cage (10). Again, a section (38) of this sidewall is made of metal lattice or of perforated metal. A panel (40) at the bottom of the left sidewall (18) hides from view the support (32) for attaching the cage (10) to the hitch of a vehicle.

The right sidewall (20) is not particularly shown in the figures herein, but would be an image mirror of left sidewall (18).

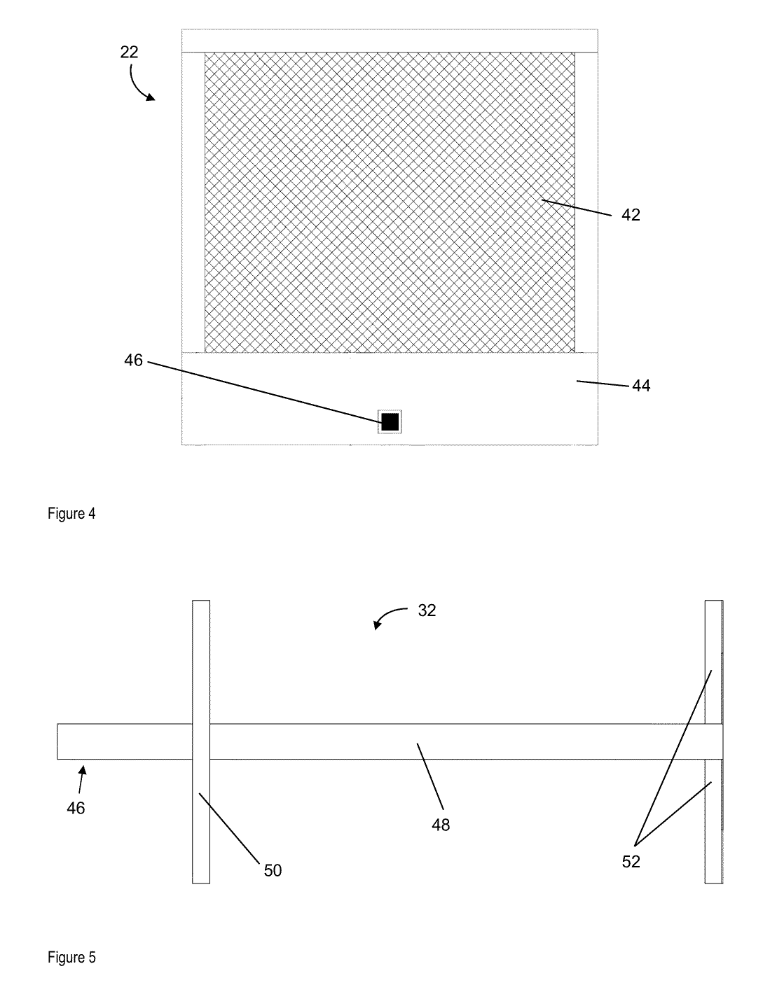

FIG. 4 is an elevation view of the back wall (22) of the cage (10). As can be seen, a section (42) of the back wall (22) is made of metal lattice or of perforated metal. Most of the support (32) is hidden from view by a panel (44) at the bottom of the back wall (22). The coupling end (46) of the central arm (48) of the support (32) is however visible.

FIG. 5 is a plan view of the support (32) for attaching the cage (10) to the trailer hitch of a vehicle. It comprises a central arm (48) having a coupling end (46). Together, the coupling end (46) and the central arm (48) consist in a bent square metal tube. The coupling end (46) is the end portion of this tube. This end portion has an opening of a size adapted to engage and retain the trailer hitch of a vehicle.

The central arm bears vertical back and front brackets (50 and 52, respectively). The back bracket (50) is positioned underneath the back wall (22) of the cage (10), while the front bracket (52) is positioned underneath the front wall (16) of the cage (10).

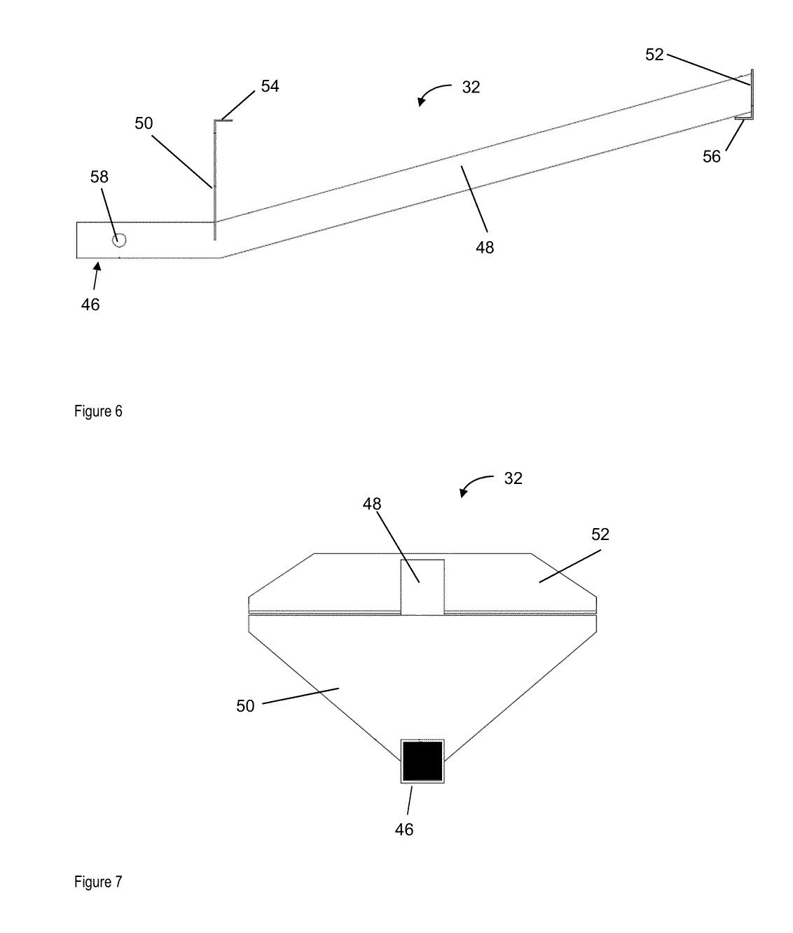

More specifically, as shown in FIG. 6, which is a side elevation view of the support (32), the back and front brackets (50 and 52) have horizontal portions (54 and 56, respectively) to receive the back wall (22) and the front wall (16). In the embodiment shown, the horizontal portion (54) of back bracket (50) is located the top of the bracket, while the horizontal portion (56) of front bracket (52) is located the bottom of the bracket.

The cage (10) is installed on a vehicle by inserting the trailer hitch thereof into the void of the square tube constituting the coupling end (46) and central arm (48). A hole (58) located at the coupling end (46) of the central arm (48) allows inserting a pin (not shown) to secure the cage (10) to the trailer hitch. When the cage (10) is thus installed, the horizontal portions (54 and 56) of the back and front brackets (50 and 52) are levelled so that the floor (12) of the cage (10) is levelled.

As can be seen in FIG. 6, the central arm slopes upward and the horizontal portions (54 and 56) of the back and front brackets (50 and 52) are located higher than the coupling end (46) of the central arm (48). As a result, the cage (10) will be held at a distance from the ground larger than the distance between the trailer hitch and the ground.

As can also be seen in FIG. 6, the back wall (22) of the cage (10) will be close to the vehicle as the distance between the coupling end (46) of the support (32) and the back bracket (50) is quite short.

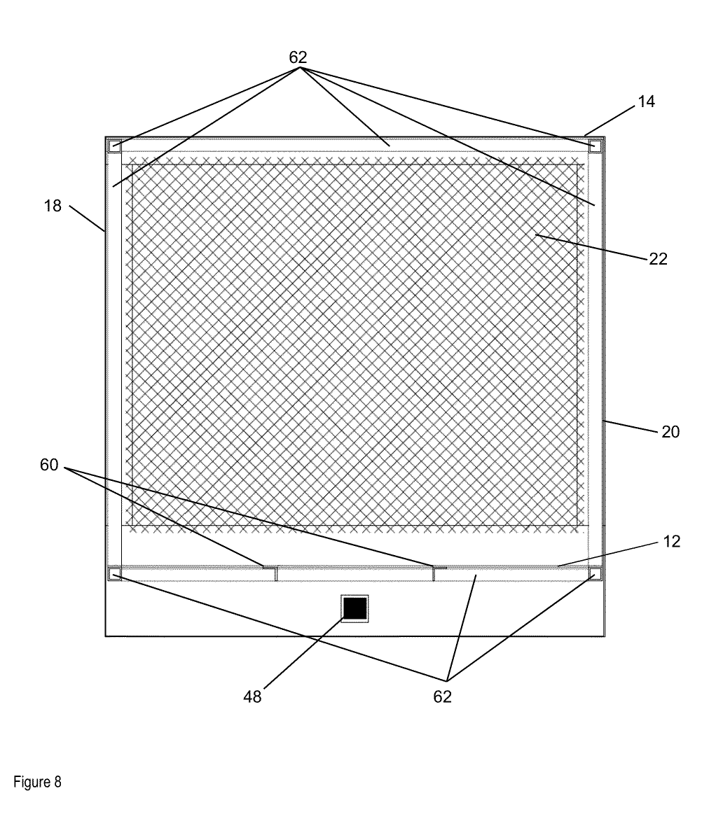

FIG. 7 is a back elevation view of the support (32) where the shape of the back bracket (50) and the front bracket (52) is visible.

FIG. 8 is a sectional view of the cage (10) along its left/right axis. The back wall (22), left and right sidewalls (18 and 20), floor (12) and top panel (14) are visible along with the central arm (48) of the support (32). In this particular embodiment, the floor (12) is strengthened by two supporting L-shaped bar (60) located beneath the floor (12) and running from the back to the front of the cage (10). Also shown are sections of an internal frame (62). This frame runs along and is attached to the edges of each of the floor (12), the top panel (14) and the four sidewalls (16, 18, 20 and 22).

FIG. 9 is a photograph showing a cage (10) according to another embodiment of the invention. The cage is installed on a car. Two dogs are in the cage (10) looking out through openings (30). Two stabilizing belts (64) are tensioned between a conventional support located on the roof of the vehicle and the top panel (14) of the cage (10). The first belt (64) is on the left side of the cage and the second belt (64) is the right side of the cage.

In the embodiment shown in the FIG. 9, two doors (24) are fitted in the front wall (16). They are mounted on hinges (28) located on the right and left sides of the front wall (16). The doors therefore meet in the middle of the front wall (16) when closed.

As can be seen in FIG. 9, the licence plate of the car has been transferred to the cage (10), where it is installed in a licence plate frame (66) located on the bottom panel (36) of the front wall (16). Rear position lamps, stop lamps and turning signals (collectively 68) are installed at the bottom of the front wall (16) and the left and right sidewalls (18, 20).

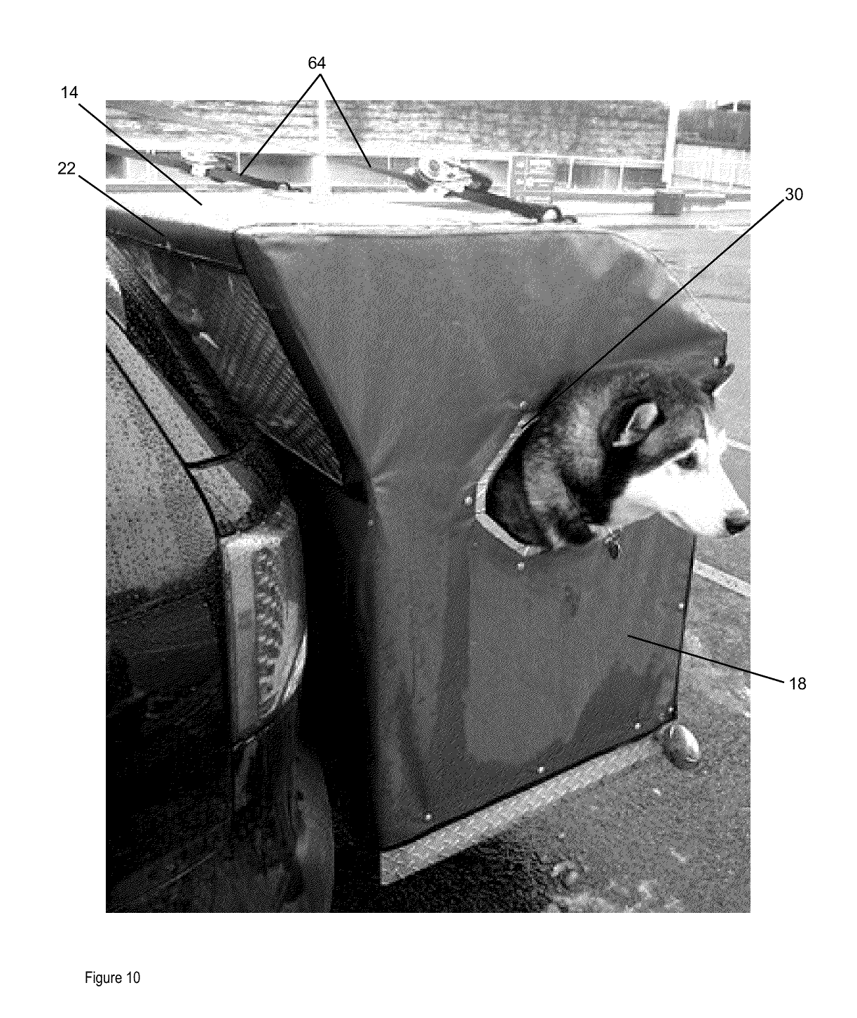

In this embodiment, the top panel (14), the front wall (16) and the left and right sidewalls (18 and 20) are made of metal sheets, while part of the back wall (22) (seen through the opening (30) on the left sidewall (18)) is made of metal lattice or of perforated metal. This back wall (22) is better seen in FIG. 10, which is another photograph of the same cage (10). This side view photograph shows that the cage (10) is close to the car.

The cage (10) shown in FIGS. 9 and 10 is an example of a cage with an irregular shape. The shape of the cage (10) is indeed adapted to the shape of the back of the car on which it is installed.

Although the present invention has been described hereinabove by way of specific embodiments thereof, it can be modified, without departing from the spirit and nature of the subject invention as defined in the appended claims.

1. A pet cage for attachment to a trailer hitch of a vehicle, the cage comprising:
a floor, one or more sidewalls and a top panel, the floor, the sidewalls and the top panel being attached together and defining an enclosed space for accommodating a pet;
a door fitted in one of the sidewalls; and
a support attached to the floor, the sidewalls and/or the top panel for supporting the cage above ground, the support having a coupling end for attachment to the trailer hitch of the vehicle.

2. The cage of claim 1, wherein, when the cage is installed on a vehicle, the support holds the cage at a distance from the ground that is equal to or larger than the distance from the ground to the trailer hitch.

3. The cage of claim 2, wherein the support holds the cage at a distance from the ground larger than the distance from the ground to the trailer hitch.

4. The cage of claim 3, wherein the support holds the cage at more than 12 inches from the ground.

5. The cage of claim 1, further comprising a pin for inserting into a hole located at the coupling end of the support so as to removably attach the support to the trailer hitch.

6. The cage of claim 1, wherein the coupling end of the support is less than 12 inches long.

7. The cage of claim 1, wherein the support extends under and is attached to the floor of the cage.

8. The cage of claim 7, wherein one or more of the sidewalls extend downward from the floor so as to at least partly hide the support from view.

9. The cage of claim 7, wherein the support comprises one or more arms extending from the coupling end under the floor of the cage.

10. The cage of claim 9, wherein the arm(s) slope upward from the trailer hitch.

11. The cage of claim 9, wherein the arm(s) are stepped.

12. The cage of claim 9, wherein one or more brackets vertically extend from the arm(s) of the support and attach to the floor of the cage.

13. The cage of claim 12, wherein two brackets extend vertically from the arm(s) of the support and attach to the floor of the cage.

14. The cage of claim 12, wherein the brackets attach to the floor under weight bearing portions thereof.

15. The cage of claim 12, wherein the brackets are L-shaped with a portion extending vertically from the arm(s) and a further portion extending horizontally from the vertical portion, the horizontal portion attaching to the floor of the cage.

16. The cage of claim 7, wherein the support comprises one central arm extending under the floor of the cage.

17. The cage of claim 16 comprising two brackets, wherein the arm(s) are stepped or slope upward from the trailer hitch, and wherein the bracket closest to the coupling end extends vertically upwards and the bracket farthest from the coupling ends extend vertically downwards.

18. The cage of claim 16, wherein the central arm and the coupling end together consist in a bent square metal tube having an opening of a size adapted to engage and retain the trailer hitch.

19. The cage of claim 1, further comprising a reinforcement frame running along and attached to the edges of each of the floor, top panel and the sidewalls.

20. The cage of claim 1, further comprising one or more stabilizing belts for attachment to the cage and to the vehicle so as to limit rocking of the cage.
